(19) United States
(12) Patent Application Publication
(10) Pub. No.: US 2014/0188495 A1
(43) Pub. Date: Jul. 3, 2014

(54) METHOD FOR ASSESSING AND MANAGING HEALTH RISKS ASSOCIATED WITH HEAVY METAL POLLUTION

(71) Applicant: NANJING UNIVERSITY, Nanjing (CN)

(72) Inventors: Jun BI, Nanjing (CN); Changsheng QU, Nanjing (CN); Yang LIU, Atalanta, GA (US); Zongwei MA, Nanjing (CN); Lei HUANG, Nanjing (CN); Xuwen CHEN, Nanjing (CN)

(73) Assignee: NANJING UNIVERSITY, Nanjing (CN)

(21) Appl. No.: 13/731,107

(22) Filed: Dec. 30, 2012

(51) Int. Cl. G06F 19/00; G06Q 50/22

(52) U.S. Cl. CPC G06F 19/3431; G06Q 50/22
USPC 705/2

(57) ABSTRACT

A method for assessing and managing health risks of heavy metal pollution. The method includes: 1) investigation and analysis of environmental pollution; 2) population exposure analysis; 3) risk assessment and representation; 4) risk perception and estimate of acceptable level of risk; 5) identification of an overall boundary of risk management; 6) identification of priority pollutants; and 7) identification of a key population and a key managing point. The method panoramically analyzes the health risk taking into account multiple sources, multiple environmental media, multiple exposure routes, and multiple receptors. The method also integrates the risk assessment, public risk perception, public acceptable risk level, and risk management to establish a comprehensive risk management strategy.

### BACKGROUND OF THE INVENTION

1. Field of the Invention

The invention relates to a method for assessing and managing health risk of heavy metal pollution.

2. Description of the Related Art

In recent years, more and more heavy metal pollutants are discharged and accumulated in the ecosystem, and accidents of health damage and mass incident caused by heavy metal pollutants occur frequently. Thus, risk assessment and management of heavy metals have been a focus of environmental protection. Extensive studies on the risk assessment and management have been conducted, most of which are focused on one or several pollutants, a single environmental media, or a certain exposure way. However, these studies neglect characteristics of heavy metals, that is, multi-sources, multi-environmental media, multi-exposure routes, and multi-receptors, so that these kinds of risk assessment do not represent a panorama of the potential health risk in a certain population. Differences in risk degrees of different pollutants, and key exposure ways of pollutants are not made clear, so that the management cannot be conducted in the whole process of the health risk.

Furthermore, health damages caused by most of the heavy metal pollutants are chronic and not easily aware; but once health damages appeared, public unrest and dissatisfaction were accompanied, bringing up social contradictions and mass incidents. However, current studies seldom take into consideration of the public perception of heavy metal pollutants. A most prominent problem is that the public perception analysis is separated from the health risk analysis. Take the conventional four steps of health risk assessment in USA as an example, results based on single risk analysis are not effectively applied in the risk management or acceptable by the public; whereas the studies on signal risk perception only represents the public physiological state but does not identify the boundary of risk management because of absence of objective risk data. Therefore, a method capable of combining the risk assessment together with the risk perception and the acceptable risk level from the potential exposure population to achieve a substantive risk management of heavy metal pollution is desired.

### SUMMARY OF THE INVENTION

In view of the above-described problems, it is one objective of the invention to provide a method for assessing and managing health risk of heavy metal pollution by which the health risk is panoramically analyzed from multi-sources, multi-environmental media, multi-exposure routes, and multi-receptors, the method integrates the risk assessment, the public risk perception, public acceptable risk level, and risk management together to establish a comprehensive risk management.

Principle of the method: system theory for risk analysis to study the whole process of health risk caused by heavy metal pollutants is employed; the characteristics of health risk, that is, multi-sources, multi-environmental media, multi-exposure routes, and multi-receptors, and control demands of the health risk are all considered for development of a method for assessing and managing health risk of heavy metal pollution; the method comprises: a risk assessment, a risk perception analysis, and a risk management, which is also called 4M3R method.

To achieve the above objective, in accordance with one embodiment of the invention, there is provided a method for assessing and managing health risk of heavy metal pollution. The method comprises the steps as follows:
1) investigation and analysis of environmental pollution: conducting an investigation, the investigation comprising aspects as follows: a discharge of a waste from a pollution source, a distribution of nearby sensitive acceptors, regional environmental factors, and weather conditions; developing an environmental investigation scheme, the investigation scheme comprising: polluted species, an arrangement of sampling regions, a sampling frequency, and a sampling time; and testing environmental samples to acquire a spatial and temporal distribution of heavy metal pollutants in multiply environmental media;
2) population exposure analysis: identifying a potential high-risk population exposed to the heavy metal pollutants; analyzing exposure ways that pose potential hazard to public health; conducting a population exposure investigation in study regions to acquire exposure parameters of native populations; and estimating population exposure doses through different ways by applying an exposure analysis model published by the US Environmental Protection Agency (EPA);
3) risk assessment and representation: based on a risk assessment model from US EPA, collecting toxicity data of heavy metal pollutants according to a “dose-response” relationship; identifying a cancer risk according to formula 1 and a non-cancer risk according to formula 2; and using the Monte Carlo method to conduct risk probability analysis and panorama analysis;
   Cancer risk:

Risk=CDI×SF Formula 1
in which, Risk represents an additional cancer risk for a life time; CDI represents a daily average chronic exposure dose; and SF represents a slop factor;
Non-cancer risk:

$$HQ = \frac{CDI}{RfD} \qquad Formula 2$$

in which, HQ represents a hazard quotient; and RfD represents a reference dose;
4) risk perception and estimate of acceptable level of risk: designing a questionnaire on a public perception of health risk by employing a psychometric paradigm; determining the number of samples; conducting the questionnaire in the study regions; analyzing the public perception of health risk caused by heavy metal pollutants; and estimating an acceptable level of risk;
5) identification of an overall boundary of risk management: for non-cancer risk, determining the risk is unacceptable when the hazard quotient is larger than or equal to 1, and determining the risk is acceptable when the hazard quotient is smaller than 1; for cancer risk, making a comparison between a result of the population health risk assessment and the public acceptable level of risk, determining the overall boundary of risk management, and identifying whether the objective risk is acceptable by the public; when the health risk is below the public acceptable level of risk, a social risk is low; and when the health risk curve intersects with an unacceptable level of risk, it means that part of the population do not accept the objective risk level. The higher an intersecting degree is, the larger the pressure of social instability is, and the more necessity of risk management is. When the objective health risk is significantly higher than the public acceptable level of risk, it is urgent to conduct risk management or control the public risk perception, thereby avoiding health damage, and maintaining the social stability;
6) identification of priority pollutants: according to an analysis result of health risk of different heavy metals, selecting pollutants that are serious polluting and have a high risk level to public health as regional priority pollutants. Generally, pollutants of cancer risk having a higher risk level than the public acceptable level of risk, and pollutants of non-cancer risk having a higher value than the reference dose are indentified as priority pollutants; and
7) identification of a key population and a key managing point: according to risk assessment results of different regions and different populations, employing a risk comparison analysis to indentify a high-risk population as a key population; conducting a panorama analysis of population health risk and investigation of population exposure, identifying a key exposure way causing health damages and a key factor affecting the level of risk as key points for population health risk management, and stipulating corresponding managing strategies.

Advantages of the invention are as follows:
The conventional methods for health risk assessment are commonly based on a certain pollutant and a single exposure way, so that they do not panoramically analyze the health risk, however, the method of the invention is more advanced and focused on the characteristics of heavy metal pollutants, that is, multi-sources, multi-environmental media, multi-exposure routes, and multi-receptors, so that it is accessible to conduct a panorama analysis, indentify the key risk managing point, and stipulate corresponding strategies in risk management.
Furthermore, analyses are based on a combination of the health risk assessment and the public risk perception, that is, results of the health risk assessment, the public perception, and public acceptable level of risk are comprehensively analyzed to identify the overall boundary of risk management. The 4M3R method is effective to identify the overall boundary of risk management, the high-risk regions and sensitive acceptors, priority pollutants, and key managing point, by which, a effective management strategies can be stipulated.

### BRIEF DESCRIPTION OF THE DRAWINGS

The invention is described hereinbelow with reference to the accompanying drawings, in which:

FIG. 1 is a flow chart of a method for assessing and managing health risk of heavy metal pollution;

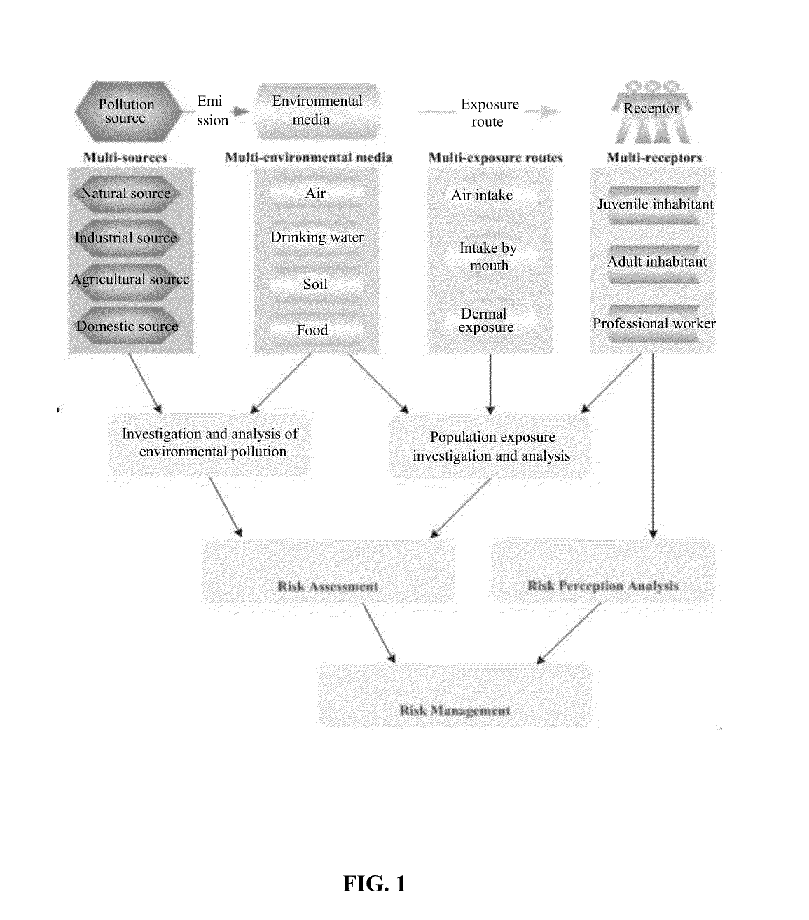

FIG. 2 is an analyzing chart of a non-cancer risk caused by the lead pollutants in residents in a vicinage of a mine; and

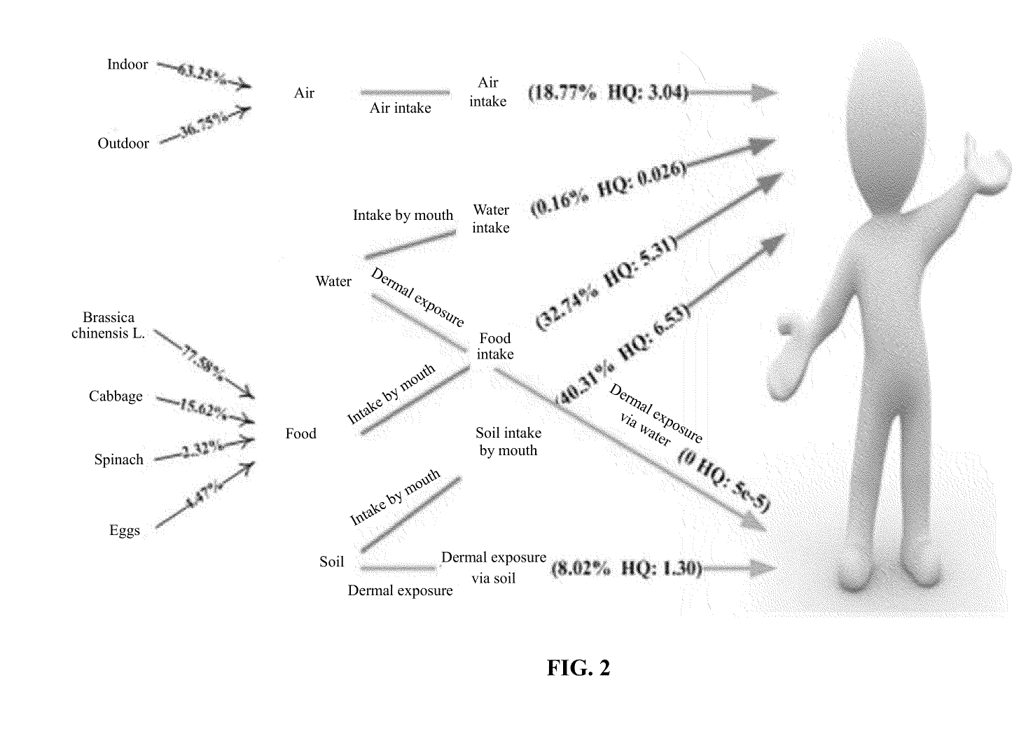

FIG. 3 is a cumulative curve chart of a cancer risk and a public unacceptable risk level.

### DETAILED DESCRIPTION OF THE EMBODIMENTS

To further illustrate the invention, experiments detailing a method for assessing and managing health risk of heavy metal pollution are described below. It should be noted that the following examples are intended to describe and not to limit the invention.

A method for assessing and managing health risk of heavy metal pollution was conducted as follows:

1) Investigation and analysis of environmental pollution: a large lead-zinc mine and a vicinage thereof was selected as a study area; a field investigation was conducted, wastes discharged from processes of ore production and transportation were identified as main risk sources, and residents living in the vicinage were identified as a main potential exposure population. Environmental samples comprising the drinking water, atmosphere, indoor air, soil, and food were collected, and concentrations of heavy metals in multiple environmental media were analyzed. A total of 13 heavy metals comprising As, Pb, Cr, an Zn were detected, in which, As was serious polluting, having 60.7 mg/kg of an average concentration in the soil and 9.9×10⁻³ mg/m³ of a concentration in the air.

2) Population exposure analysis: a population exposure investigation was conducted among 120 residents to know about the exposure parameters of the native people, these exposure parameters comprised: an amount of the drinking water, diet structure, and activity. Exposure ways of the residents comprised: drinking water intake, air intake, dermal exposure via the water and the soil, soil and food intake by mouth. Population exposure doses through different ways were estimated by applying an exposure analysis model disclosed by the US E EPA.

3) Risk assessment and representation: slop factors (SF) of heavy metals, and reference doses were referred from the IRIS database of US EPA. Cancer risk was calculated in compliance with formula 1, and non-cancer risk was calculated in compliance with formula 2 (results are shown in Table 1). Monte Carlo method was employed to conduct sampling calculation to acquire probability distribution of health risk values and contribution rates of different exposure ways.

TABLE 1
Hazard quotients of heavy metals of non-cancer risk

| | Average | Standard deviation |
|---|---|---|
| Ag | 0.0009 | 0.0005 |
| As | 174 | 99.6 |
| Be | 0.034 | 0.148 |
| Cd | 3.32 | 1.91 |
| Cr | 0.001 | 0.0008 |
| Cu | 0.189 | 0.046 |
| Ni | 0.423 | 0.146 |
| Pb | 16.2 | 6.96 |
| Sb | 1.36 | 0.514 |
| Se | 0.018 | 0.015 |
| TI | 0.175 | 0.062 |
| Zn | 0.301 | 0.076 |
| Hg | 2.84 | 1.06 |
| Total of hazard quotients | 198.8 | 100.3 |

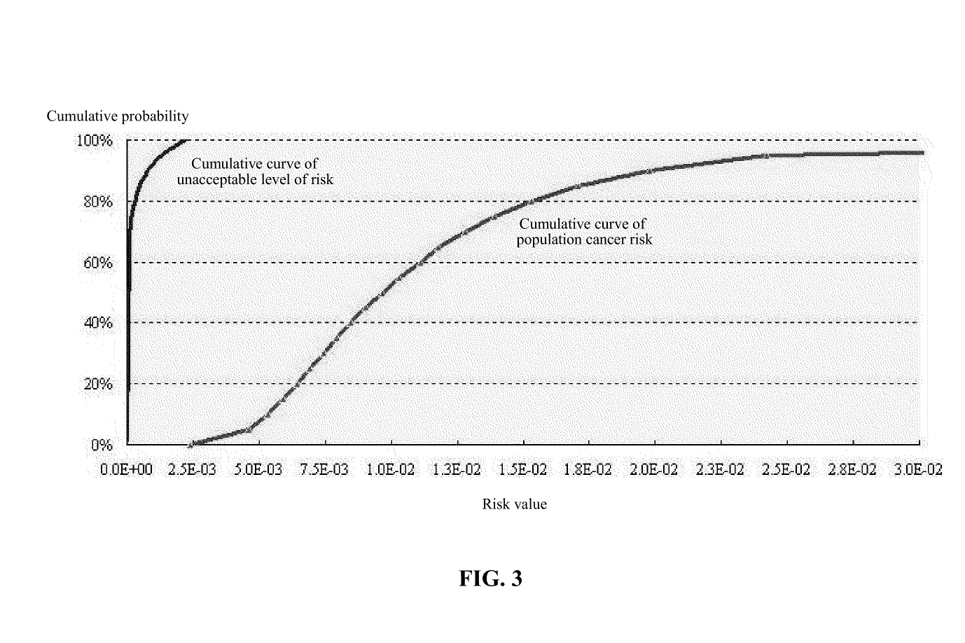

4) Risk perception and estimate of acceptable level of risk: a questionnaire on public risk perception (shown in Table 2) was designed by employing a psychometric paradigm. The questionnaire was conducted in a form of interview among 240 samples. Public perceptions of health risk of heavy metals were analyzed, and results of acceptable level of risk were represented as a cumulative curve (as shown in FIG. 3).

TABLE 2
Questionnaire on public perception of cancerigenic heavy metals risk
Supposing that accidents of cancer risks occur in a city having 8 million residents
because of heavy metal pollutants, what do you think about the following conditions:

| | | | | | Very | |
|---|---|---|---|---|---|---|
| | | | | | difficult | |
| | Fully | | Reluctantly | Difficult | to | |
| | acceptable | Acceptable | acceptable | to accept | accept | Unacceptable |
| 1 person suffers | | | | | | |
| from cancer every | | | | | | |
| year due to heavy | | | | | | |
| metal pollutants | | | | | | |
| 8 persons suffer | | | | | | |
| from cancer every | | | | | | |
| year due to heavy | | | | | | |
| metal pollutants | | | | | | |
| 40 persons suffers | | | | | | |
| from cancer every | | | | | | |
| year due to heavy | | | | | | |
| metal pollutants | | | | | | |
| 80 persons suffers | | | | | | |
| from cancer every | | | | | | |
| year due to heavy | | | | | | |
| metal pollutants | | | | | | |
| 800 persons suffers | | | | | | |
| from cancer every | | | | | | |
| year due to heavy | | | | | | |
| metal pollutants | | | | | | |
| 8000 persons | | | | | | |
| suffers from cancer | | | | | | |
| every year due to | | | | | | |
| heavy metal | | | | | | |
| pollutants | | | | | | |

5) Identification of an overall boundary of risk management: for non-cancer risk, 6 heavy metals, i. e., As, Pb, Be, Cd, Sb, and Hg, had a hazard quotient larger than 1, which meant that risk values of these non-cancer risk were unacceptable by the public. For cancer risk, results of the population health risk assessment and public acceptable level of risk were compared, as shown in FIG. 3, the cancer risk value was significantly higher than the public acceptable level of risk, which meant that it was urgent to conduct risk management or control of public risk perception.

6) Identification of priority pollutants: pollutants of cancer risk having a higher risk level than the public acceptable level, and pollutants of non-cancer risk having a higher value than the reference dose are indentified as priority pollutants. Thus, As, Pb, Be, Cd, Sb, and Hg were identified as priority pollutants in the lead zinc mine.

7) Identification a key population and a key managing point: according to risk assessment results of different regions and different population, residents in the vicinage of the lead zinc mine were identified as a key population. From the panorama analysis of population health risk and investigation of population exposure, air intake turned out to be the key exposure way, and 99% above cancer risk of heavy metal pollutants were through air intake. For the non-cancer risk, for example, the non-risk caused by lead, risk analysis was shown in FIG. 3. Soil was the main exposure way, in which, soil intake through mouth was more than 40% of a total hazard quotient; ⅓ of the exposure was through the food intake, in which, the risk of the intake of native brassica chinensis L. and Brassica campestris L. ssp. chinensis (L.) Makino. var. communis Tsen et Lee were more than 90% of the risk of food intake. The air intake was ⅕ of a total exposure. Thus, risk management strategies comprised: decreasing the indoor air exposure and the time of the outdoor exposure, avoiding soil through dermal exposure and intake, and decreasing the intake of the native vegetables.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for assessing and managing health risks of heavy metal pollution, the method comprising:
1) investigation and analysis of environmental pollution: conducting an investigation, the investigation comprising aspects as follows: a discharge of a waste from a pollution source, a distribution of nearby sensitive acceptors, regional environmental factors, and weather conditions; developing an environmental investigation scheme, the investigation scheme comprising: polluted species, an arrangement of sampling regions, a sampling frequency, and a sampling time; and testing environmental samples to acquire a spatial and temporal distribution of heavy metal pollutants in multiply environmental media;
2) population exposure analysis: identifying a potential high-risk population exposed to the heavy metal pollutants; analyzing exposure ways that are potentially hazard to public health; conducting a population exposure investigation in study regions to acquire exposure parameters of native populations; and estimating population exposure doses through different ways by applying an exposure analysis model disclosed by the US Environmental Protection Agency (EPA);
3) risk assessment and representation: based on a risk assessment model from US EPA, collecting toxicity data of heavy metal pollutants according to a “dose-response” relationship; identifying a cancer risk according to formula 1 and a non-cancer risk according to formula 2; and using the Monte Carlo method to conduct risk probability analysis and panorama analysis;
cancer risk:
Risk=CDI×SF Formula 1
in which, Risk representing an additional cancer risk for a life time; CDI representing a daily average chronic exposure dose; and SF representing a slop factor;
non-cancer risk:
$$HQ = \frac{CDI}{RfD} \qquad Formula 2$$
in which, HQ representing a hazard quotient; and RfD representing a reference dose;
4) risk perception and estimate of an acceptable level of risk: designing a questionnaire on a public perception of health risk by employing a psychometric paradigm; determining the number of samples; conducting the questionnaire in the study regions; analyzing the public perception of health risk caused by heavy metal pollutants; and estimating the acceptable level of risk;
5) identification of an overall boundary of risk management:
for non-cancer risk, determining the risk is unacceptable when the hazard quotient is larger than or equal to 1, and the risk is acceptable when the hazard quotient is smaller than 1;
for cancer risk, comparing a result of the population health risk assessment and the public acceptable level of risk, determining the overall boundary of risk management, and identifying whether the objective risk is acceptable by the public;
6) identification of priority pollutants: according to an analysis result of health risk of different heavy metals, selecting pollutants that are serious polluting and have a high risk level to public health as regional priority pollutants, the priority pollutants comprising pollutants of cancer risk having a higher risk level than the public acceptable level of risk, and pollutants of non-cancer risk having a higher value than the reference dose; and
7) identification of a key population and a key managing point: according to risk assessment results of different regions and different populations, employing a risk comparison analysis to indentify a high-risk population as a key population; conducting a panorama analysis of population health risk and investigation of population exposure, identifying a key exposure way causing health damages and a key factor affecting the level of risk as key points for population health risk management, and stipulating corresponding managing strategies.
